(19) United States
(12) Patent Application Publication
(10) Pub. No.: US 2026/0245941 A1
(43) Pub. Date: Aug. 20, 2026

(54) FUEL CELL STACK

(71) Applicant: Honda Motor Co., Ltd., Tokyo (JP)

(72) Inventors: Yuta Oshima, Saitama (JP); Takuma Nozaki, Saitama (JP)

(21) Appl. No.: 19/538,891

(22) Filed: Feb. 12, 2026

(30) Foreign Application Priority Data
Feb. 18, 2025 (JP) 2025-024595

(51) Int. Cl. H01M 8/248; H01M 8/2475; H01M 8/2483; H01M 8/10

(52) U.S. Cl. CPC H01M 8/248; H01M 8/2475; H01M 8/2483; H01M 2008/1095; H01M 2250/20

(57) ABSTRACT

A fuel cell stack including a cell stacked body including a plurality of power generation cells stacked in a predetermined direction, a housing surrounding the cell stacked body, and a restraining member made of a resin and disposed in a space between an inner surface of the housing and an outer surface of the cell stacked body, the restraining member having a facing surface opposed to the inner surface and extending in the predetermined direction. The inner surface includes a rib on a housing side protruding toward the facing surface, the facing surface includes a rib on a restraining member side protruding toward the inner surface, and the rib on the restraining member side includes an abutment rib provided so as to abut against an end surface of the rib on the housing side.

### CROSS-REFERENCE TO RELATED APPLICATION

This application is based upon and claims the benefit of priority from Japanese Patent Application No. 2025-024595 filed on February 18, 2025, the content of which is incorporated herein by reference.

### BACKGROUND OF THE INVENTION

### Field of the Invention

This invention relates to a fuel cell stack.

### Description of the Related Art

In recent years, technological developments have been made on a fuel cell that contribute to energy efficiency in order to ensure access to energy that is affordable, reliable, sustainable and advanced by more people. As a conventional technology related to a fuel cell stack used in this type of fuel cell, there is a known technology in which a restraining member is provide between a cell stacked body and a case to restrain the position of the cell stacked body. Such technology is described, for example, in Japanese Examined Patent Publication No. 6870603 (JP 6870603 B). In the fuel cell stack (fuel cell unit) described in JP 6870603 B, a plurality of resin restraining members are disposed in the stacking direction of the cell stacked body.

In this regard, to effectively restrain the position of the cell stacked body, it is preferable to form the restraining member along the stacking direction of the cell stacked body. However, in such cases, the restraining member has an elongated shape, and therefore tends to warp during resin molding, which may impair dimensional accuracy.

### SUMMARY OF THE INVENTION

An aspect of the present invention is a fuel cell stack including: a cell stacked body including a plurality of power generation cells stacked in a predetermined direction; a housing surrounding the cell stacked body; and a restraining member made of a resin and disposed in a space between an inner surface of the housing and an outer surface of the cell stacked body, the restraining member having a facing surface opposed to the inner surface and extending in the predetermined direction. The inner surface includes a rib on a housing side protruding toward the facing surface, the facing surface includes a rib on a restraining member side protruding toward the inner surface, and the rib on the restraining member side includes an abutment rib provided so as to abut against an end surface of the rib on the housing side.

### BRIEF DESCRIPTION OF THE DRAWINGS

The objects, features, and advantages of the present invention will become clearer from the following description of embodiments in relation to the attached drawings, in which:

FIG. 1 is a perspective view schematically illustrating an overall configuration of a fuel cell stack according to an embodiment of the present invention;

FIG. 2 is a cross-sectional view taken along line II-II of FIG. 1;

FIG. 3A is a perspective view illustrating a configuration of an inner wall surface at a lower left corner of a case in FIG. 1;

FIG. 3B is a perspective view illustrating a state in which a holding bar is attached to the inner wall surface at the lower left corner of the case in FIG. 1;

FIG. 4 is a cross-sectional view taken along line IV-IV of FIG. 3B;

FIG. 5 is a view indicated by an arrow V in FIG. 3B;

FIG. 6 is a cross-sectional view taken along line VI-VI of FIG. 4;

FIG. 7 is a diagram schematically illustrating a flow of gas by the fuel cell stack according to the embodiment of the present invention;

FIG. 8 is a view indicated by an arrow VIII in FIG. 5;

FIG. 9 is a view indicated by an arrow IX in FIG. 8;

FIG. 10 is a cross-sectional view taken along line X-X of FIG. 9;

FIG. 11 is an enlarged view of a main portion of FIG. 9;

FIG. 12A is a view illustrating a modification of FIG. 9; and

FIG. 12B is a view illustrating another modification of FIG. 9.

### DETAILED DESCRIPTION OF THE INVENTION

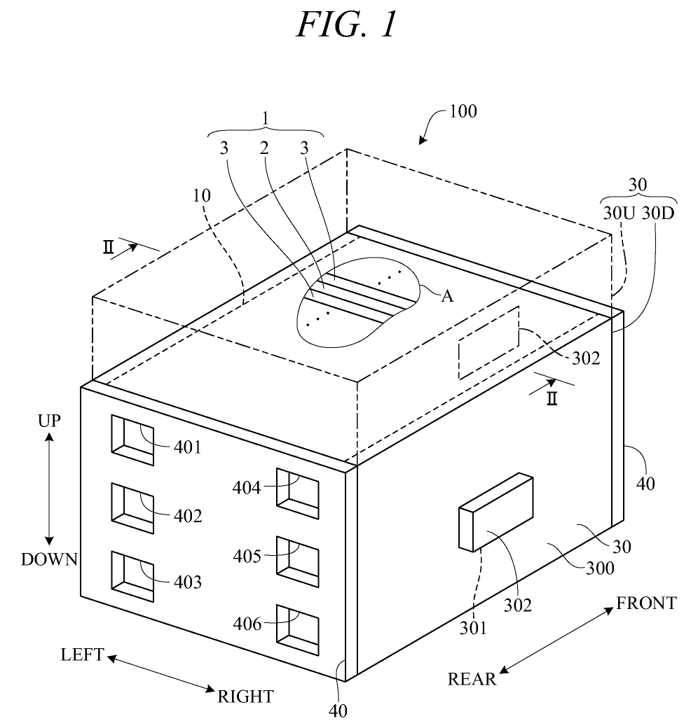

Hereinafter, an embodiment of the present invention will be described with reference to FIGS. 1 to 12B. A fuel cell stack according to an embodiment of the present invention is a main component of a fuel cell. The fuel cell is mounted on, for example, a vehicle and can generate electric power for driving the vehicle. The fuel cell can be mounted on various industrial machines in addition to a moving body other than a vehicle such as an aircraft or a boat, a robot, and the like.

FIG. 1 is a perspective view schematically showing an overall configuration of a fuel cell stack 100 according to the embodiment of the present invention. Hereinafter, for the sake of convenience, three-axis directions orthogonal to each other as illustrated in the drawing are defined as a front-rear direction, a left-right direction, and an up-down direction, and a configuration of each unit will be described according to such definitions. The down direction in the up-down direction in FIG. 1 corresponds to the direction of gravity. The front-rear direction in FIG. 1 corresponds to a stacking direction of the fuel cell stack 100. The front-rear and left-right directions in FIG. 1 do not necessarily coincide with the front-rear and left-right directions of a vehicle.

As illustrated in FIG. 1, the fuel cell stack 100 includes a cell stacked body 10, end units 40 disposed on both ends in the front-rear direction of the cell stacked body 10, and a case 30 arranged around the cell stacked body 10 to surround the cell stacked body 10, and the whole of the fuel cell stack 100 has a substantially rectangular parallelepiped shape. The length of the fuel cell stack 100 in the left-right direction is longer than the length in the up-down direction.

The case 30 has four substantially rectangular side walls 300, that is, side walls provided on the top, bottom, left, and right faces of the case 30. These four side walls 300 form a substantially box-shaped housing space SP0 with open the front and rear surfaces. The case 30 is composed of metals such as aluminum or iron. The case 30 in FIG. 1 may be configured as a lower case 30D, with an upper case 30U indicated by a two-dot chain line provided above the lower case 30D. In such a case, the lower case 30D and the upper case 30U together constitute the fuel cell case 30.

In part “A” of FIG. 1, a portion of the upper wall 31 of the case 30 is shown as broken. As illustrated in part “A” of FIG. 1, the cell stacked body 10 is configured by stacking multiple power generation cells 1 (for convenience, only a single power generation cell 1 is shown) in the front-rear direction and formed in a substantially rectangular parallelepiped shape as a whole. The power generation cell 1 has a unitized electrode assembly (hereinafter, referred to as a “UEA”) 2 including a membrane electrode assembly having an electrolyte membrane and an electrode, and separators 3 arranged on both front and rear sides of the UEA 2 to sandwich the UEA 2. The UEA 2 and the separator 3 are alternately arranged in the front-rear direction. The separator 3 has a pair of metal thin plates with corrugated-shaped cross-sections, and the outer peripheral portions of this pair of thin plates are joined to form an integrated structure. A cooling flow path is formed within the pair of thin plates through which a cooling medium (e.g., water) flows. The power generation surface of the power generation cell 1 is cooled through the flow of the cooling medium. The UEA2 can also be referred to as a membrane electrode structure.

The separator 3 on the front side of the UEA 2 is, for example, the anode side separator (anode separator), and an anode flow path through which fuel gas containing hydrogen flows is formed between the anode separator 3 and the membrane electrode assembly of the UEA 2. The separator 3 on the rear side of the UEA 2 is, for example, the cathode side separator (cathode separator), and a cathode flow path through which oxidant gas containing oxygen flows is formed between the cathode separator 3 and the membrane electrode assembly of the UEA 2.

The UEA 2 includes a membrane electrode assembly (hereinafter, referred to as a “MEA”) and a resin frame supporting the surroundings of the MEA. The MEA has an electrolyte membrane, an anode electrode provided on a front surface of the electrolyte membrane, and a cathode electrode provided on a rear surface of the electrolyte membrane. The electrolyte membrane is, for example, a solid polymer electrolyte membrane. The anode electrode has an electrode catalyst layer formed on the front surface of the electrolyte membrane and served as a reaction field for electrode reaction, and a gas diffusion layer formed on the front surface of the electrode catalyst layer to spread and supply the fuel gas. The cathode electrode has an electrode catalyst layer formed on the rear surface of the electrolyte membrane and served as a reaction field for electrode reaction, and a gas diffusion layer formed on the rear surface of the electrode catalyst layer to spread and supply the oxidant gas.

In the anode electrode, the fuel gas (hydrogen) supplied through the anode flow path and the gas diffusion layer is ionized by an action of a catalyst, passes through the electrolyte membrane, and moves to the cathode electrode side. Electrons generated at this time pass through an external circuit and are extracted as electric energy. In the cathode electrode, an oxidant gas (oxygen) supplied via the cathode flow path and the gas diffusion layer reacts with hydrogen ions guided from the anode electrode and electrons moved from the anode electrode to generate water. The generated water gives an appropriate humidity to the electrolyte membrane, and excess water is discharged to an outside of the UEA 2.

In the rear end unit (e.g., end plate, not shown) 40, through-holes 401 to 406 penetrating the end unit 40 in the front-rear direction are formed. The through-holes 401 to 403 are arranged near the left end of the end unit 40 with positions shifted vertically, and the through-holes 404 to 406 are arranged near the right end with positions shifted vertically. The through-holes 401 to 406 are not formed in the front side end unit 40.

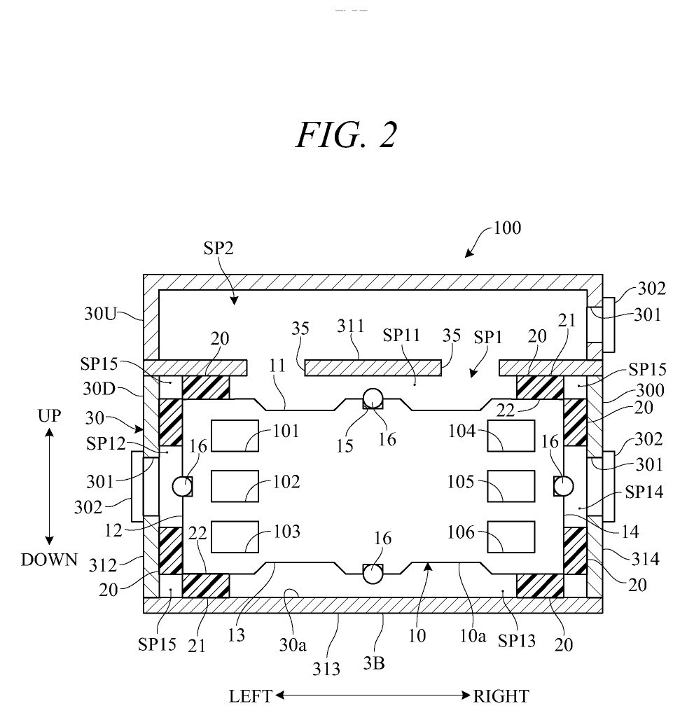

FIG. 2 is a cross-sectional view along the line II-II of FIG. 1. FIG. 2 shows an example where the case 30 is configured by the lower case 30D and the upper case 30U. As illustrated in FIG. 2, in the cell stacked body 10 (multiple power generation cells 1), multiple through-holes 101 to 106 are formed at positions corresponding to the through-holes 401 to 406 in the end unit 40. The through-holes 101 to 106 include the through-holes provided in the UEA 2 and the through-holes provided in the separator 3.

The fuel gas is supplied into the cell stacked body 10 via the through-hole 401 of the end unit 40. This fuel gas is guided to the anode flow paths of multiple power generation cells 1 via the through-hole 101 of the cell stacked body 10. The fuel gas that has passed through the anode flow path is discharged from the through-hole 406 of the end unit 40 via the through-hole 106. The oxidant gas is supplied into the the cell stacked body 10 via the through-hole 404 of the end unit 40. This oxidant gas is guided to the cathode flow paths of multiple power generation cells 1 via the through-hole 104 of the cell stacked body 10. The oxidant gas that has passed through the cathode flow path is discharged from the through-hole 403 of the end unit 40 via the through-hole 103. The cooling medium is supplied into the cell stacked body 10 via the through-hole 405 of the end unit 40. This cooling medium is guided to the cooling flow paths of multiple power generation cells 1 via the through-hole 105 of the cell stacked body 10. The cooling medium that has passed through the cooling flow path is discharged from the through-hole 102 of the end unit 40 via the through-hole 102.

The case 30 (lower case 30D) has four side walls 300, that is, the upper wall 311 and lower wall 313 extending in approximately horizontal direction, and left wall 312 and right wall 314 extending in approximately vertical direction. The four side walls 300 are formed using metal materials such as iron and aluminum, for example by casting. The end portions of the four side walls 300 (311-314) adjacent to each other are fastened together with bolts (not shown) to form the lower case 30D. Within the lower case 30D, a substantially box-shaped space SP1 is formed.

The upper wall 311 forms a partition wall that separates the lower case 30D and the upper case 30U. The upper case 30U is fixed to the upper surface of the upper wall 311. Within the upper case 30U, a substantially box-shaped space SP2 is formed. In the space SP2, a control unit (e.g., a voltage control unit) that controls the operation of the fuel cell can be accommodated. In the upper wall 311, a communication port 35 that penetrates the upper wall 311 is formed, and through the communication port 35, the space SP1 in the lower case communicates with the space SP2 in the upper case.

A holding bar 20 is interposed as an impact receiving member between an inner wall surface (case inner wall surface) 30a of the side wall 300 of the case 30 (lower case 30D) and an outer surface 10a of the cell stacked body 10. Specifically, when four sides of the cell stacked body 10 (e.g., the separator 3) are defined as an upper side 11, a left side 12, a lower side 13, and a right side 14, a pair of holding bars 20 are disposed between the upper side 11 and the case inner wall surface 30a, between the left side 12 and the case inner wall surface 30a, between the lower side 13 and the case inner wall surface 30a, and between the right side 14 and the case inner wall surface 30a. The pair of holding bars 20 is provided near a corner of the cell stacked body 10. In other words, the pair of holding bars 20 are disposed near each of the four corners of the cell stacked body 10 so as to sandwich the corner. The distances from the corner of the cell stacked body 10 to the pair of holding bars 20 are the same, and the pair of holding bars 20 are arranged symmetrically with the corner interposed therebetween.

The disposition near the corner of the cell stacked body 10 means that the holding bar 20 is disposed at least closer to the corner than the longitudinally center position of each of the sides 11 to 14 of the cell stacked body 10, or that the holding bar 20 is disposed within a predetermined distance from the corner of the cell stacked body 10. Alternatively, it means that the holding bar 20 is disposed in a corner area when each of the sides 11 to 14 of the cell stacked body 10 is divided into at least four equal parts.

The holding bar 20 has a substantially rectangular cross section, and extends over substantially the entire length in the front-rear direction of the cell stacked body 10. The plurality of holding bars 20 have the same cross-sectional shape. The holding bar 20 is an elastic body of a resin material, rubber or the like, and is made of an insulator. The holding bar 20 is attached to the case inner wall surface 30a in advance, for example, and is provided integrally with the case 30. By providing the holding bar 20 near the corner of the cell stacked body 10, when an impact acts on the case 30 in a direction orthogonal to the stacking direction of the cell stacked body 10, the vicinity of the corner of the cell stacked body 10 abuts against the holding bar 20 by an inertial force. Accordingly, a positional shift of the power generation cell 1 can effectively be suppressed.

The single UEA 2 and the single separator 3 are integrated by welding in advance to form a unit cell. A plurality of recessed positioning portions 15 are provided in a peripheral edge portion of the unit cell (e.g., the separator 3). In the case, a plurality of guide members 16 are arranged to correspond to the positioning portions 15. The guide member 16 is configured to have a cross-sectional shape constant from a lower end to an upper end thereof (from a rear end to a front end thereof in FIG. 1). The plurality of guide members 16 have the same shape, and their cross-sectional shapes are, for example, circular. The lower ends and the upper ends of the plurality of guide members 16 are fitted into recesses or through holes provided in the end unit 40, thereby holding the guide members 16 at predetermined positions in the case.

The plurality of unit cells are stacked while the positioning portions 15 are fitted into the guide members 16. As a result, the unit cells can be positioned with respect to the case 30, thereby configuring the cell stacked body 10 with high accuracy. The guide members 16 may have a substantially L-shaped cross section or a substantially T-shaped cross section instead of the circular cross section. The guide members 16 may be supported by the case 30 instead of the end unit 40. The guide members 16 may be provided at the corners of the cell stacked body 10, and the positions and number of the guide members 16 are not limited to those illustrated in FIG. 2.

The substantially frame-shaped space (also referred to as surplus space) SP1 between the cell stacked body 10 and the case 30 (lower case 30D) is divided into a plurality of spaces in the circumferential direction by the holding bars 20. Specifically, it is divided into an upper space (upper space SP11), a left space (left space SP12), a lower space (lower space SP13), a right space (right space SP14), and a corner space (corner space SP15) with respect to the cell stacked body 10.

The holding bar 20 has an outer end surface 21 facing the case inner wall surface 30a and an inner end surface 22 facing the outer surface 10a of the cell stacked body 10. The outer end surface 21 abuts against the case inner wall surface 30a. On the other hand, there is a small gap between the inner end surface 22 and the outer surface 10a of the cell stacked body 10. Therefore, communication between the plurality of spaces (for example, the left space SP12 and the lower space SP13) is blocked by the holding bars 20. As a result, there is no gas flow between the plurality of spaces, or there is only a slight gas flow through the gap between the inner end surface 22 of the holding bar 20 and the outer surface 10a of the cell stacked body 10.

Meanwhile, gas flow paths (anode flow path and cathode flow path) of the cell stacked body 10 are sealed by a seal member provided between the UEA 2 and the separator 3 so as to surround the gas flow paths. The seal member is made of flexible rubber, resin, or the like, and adheres tightly to the surfaces of the UEA 2 and the separator 3 to ensure airtightness. A certain degree of gas leaks from the inside of the cell stacked body 10 through such a seal member. The leaked gas is accumulated in the surplus space SP1. Therefore, the concentration of hydrogen gas contained in the fuel gas may increase in the surplus space SP1.

In order to suppress such an increase in the concentration of the fuel gas, a ventilation device is provided in a fuel cell stack 100 according to the present embodiment. The ventilation device includes a plurality of ventilation ports 301 provided to penetrate the side walls 300 of the case 30, and filter units 302 attached to face the ventilation ports 301.

The filter unit 302 includes a cover attached to the side wall 300 from the outside of the side wall 300 with a bolt or the like so as to cover the ventilation port 301, and a filter fixedly provided on the cover so as to shield the ventilation port 301. The cover has a mesh portion and a louver portion that cover the ventilation port 301, and prevents intrusion of relatively large foreign matter into the case 30 to protect the filter. The filter is an air filter, and removes dust and the like from the gas passing through the filter, particularly air flowing into the case 30 from the outside, thereby preventing intrusion of dust and the like into the case 30 to protect the cell stacked body 10.

By providing the ventilation port 301 and the filter unit 302 to face each of the spaces SP11 to SP15 in the case, the plurality of spaces SP11 to SP15 can be ventilated. However, when the number of filter units 302 increases, the cost increases, the configuration of the surface of the case 30 becomes complicated, which increases the size of the fuel cell stack 100. Therefore, the number of ventilation ports 301 and the number of filter units 302 are preferably as small as possible. However, when the number of ventilation ports 301 and the number of filter units 302 are reduced, there are spaces where ventilation ports are provided (referred to as open spaces) and spaces where ventilation ports are not provided (referred to as closed spaces), making it difficult to sufficiently ventilate the closed spaces.

In the present embodiment, a communication flow path for allowing communication between the open space and the closed space is provided as will be described below, thereby allowing gas to flow from the closed space to the open space. Therefore, the ventilation ports 301 and the filter units 302 are provided to face only some of the plurality of spaces SP11 to SP15. Specifically, the ventilation ports 301 are provided on the left wall 312 and the right wall 314 of the lower case 30D and the right wall of the upper case 30U so as to face the spaces SP12, SP14 and SP2, respectively. The filter units 302 are provided to face these ventilation ports 301. The configurations of the plurality of ventilation ports 301 and the configurations of the plurality of filter units 302 are the same.

When the ventilation ports 301 are provided to face the spaces SP12, SP14, and SP2 in this manner, the left space SP12, the right space SP14, and the upper space SP2 become open spaces, and the lower space SP13 and the corner space SP15 become closed spaces. The upper space SP11 communicates with the space SP2 via a communication port 35, and thus becomes an open space.

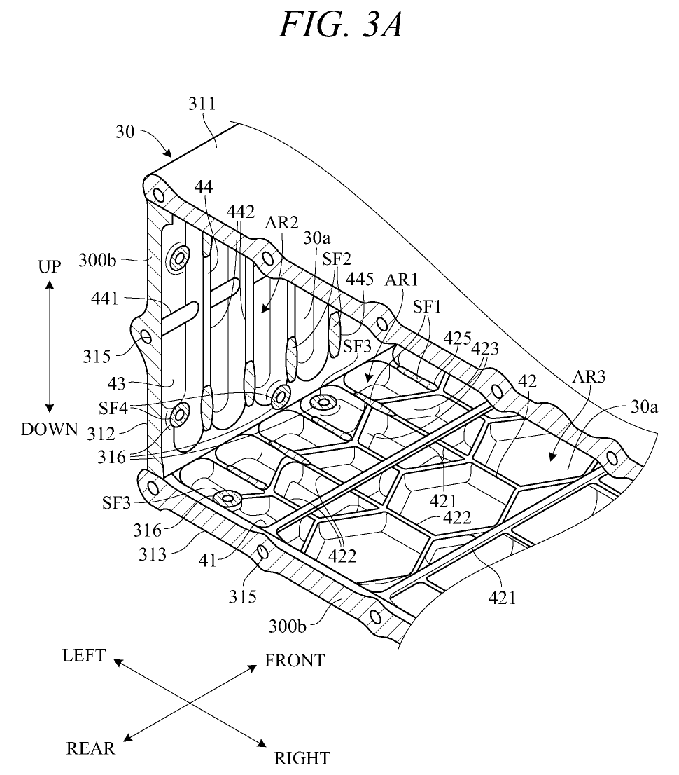

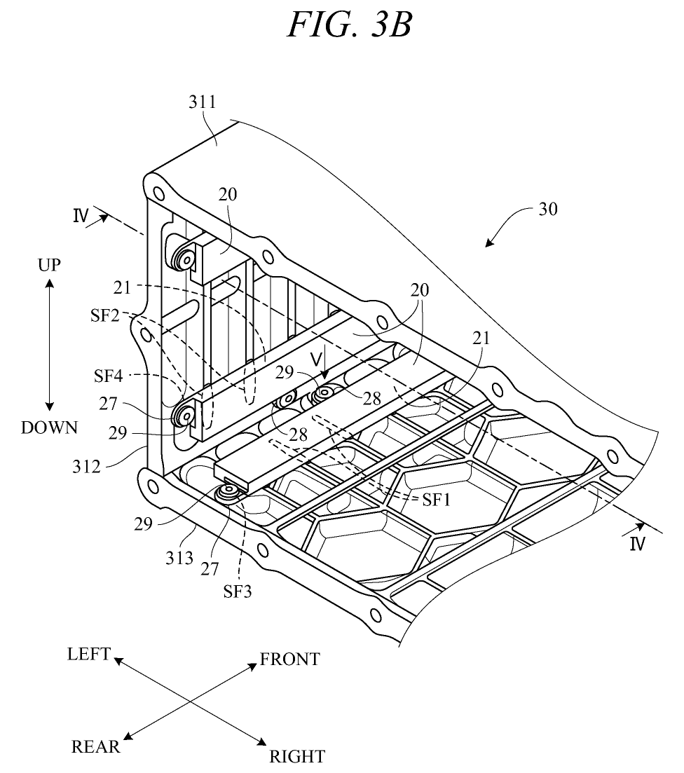

Hereinafter, the configuration of the communication flow path that allows communication between the open space and the closed space will be described. FIGS. 3A and 3B are perspective views (views seen obliquely on the right side from the rear side) illustrating a configuration of the inner wall surface 30a at a lower left corner on a rear end side of the case 30 where the left wall 312 and the lower wall 313 of the case 30 cross each other. FIG. 3A illustrates a state before the holding bar 20 is attached to the case inner wall surface 30a, and FIG. 3B illustrates a state after the holding bar 20 is attached. FIG. 4 is a cross-sectional view of a main portion of the case 30 taken along line IV-IV of FIG. 3B. Although not illustrated, the configurations of the upper left corner, the upper right corner, and the lower right corner of the case 30 and the configurations of the corner on the front end side of the case 30 are the same as those illustrated in FIGS. 3A, 3B, and 4.

A machined surface (flange surface or seating surface) machined as a flat surface by machining is provided in a predetermined portion of the case 30 formed by casting. In FIG. 3A, the machined surface is indicated by hatching for convenience. The machined surface includes a rear end machined surface formed on a rear end surface 300b of the side wall 300. A plurality of screw holes 315 facing forward are provided in the rear end surface 300b. The bolt (not illustrated) inserted through the through hole of the end unit 40 (FIG. 1) is screwed into the screw hole 315, thereby fastening the end unit 40 to the rear end surface 300b of the side wall 300.

As illustrated in FIGS. 3A and 4, the lower wall 313 includes a flat plate portion 41 extending in a substantially horizontal direction with a constant thickness, and a plurality of ribs 42 protruding upward from an upper surface 41a of the flat plate portion 41, and the inner wall surface 30a of the lower wall 313 is entirely uneven. The ribs 42 include a plurality of longitudinal ribs 421 extending in the front-rear direction, a plurality of transverse ribs 422 extending in the left-right direction, and cross ribs 423 extending in a direction crossing the plurality of transverse ribs 422 and connecting the transverse ribs 422 to each other. The longitudinal ribs 421 are provided so as to coincide with the positions of the screw holes 315.

On the inner wall surface 30a of the lower wall 313, an attachment region AR1 for the holding bar 20 is provided between the left end of the lower wall 313 and the longitudinal rib 421 on the right side thereof. In each of the attachment region AR1 and the non-attachment region AR3 on the right side of the attachment region AR1, a plurality of transverse ribs 422 are provided at equal intervals in the front-rear direction. The number of transverse ribs 422 in the attachment region AR1 is larger than the number of transverse ribs 422 in the non-attachment region AR3, and is, for example, twice the number of transverse ribs 422 in the non-attachment region AR3. The number of transverse ribs 422 in the attachment region AR1 may be equal to the number of transverse ribs 422 in the non-attachment region AR3. That is, the transverse rib 422 in the non-attachment region AR3 may be provided on the extension line of each of the transverse ribs 422 in the attachment region AR1.

In the attachment region AR1, an attachment surface SF1 for the holding bar 20 is formed as a machined surface (hatched). Specifically, as illustrated in FIG. 4, in the central portion in the left-right direction of the transverse rib 422 in the attachment region AR1, a high rib portion 425 higher than the other portion of the transverse rib 422 and the cross rib 423 is formed in the casting process. Before the case 30 is assembled, that is, while the lower wall 313 is in a separate state, the upper surface of the high rib portion 425 is machined to form an attachment surface SF1 on the same horizontal plane that extends in the front-rear direction. The attachment surface SF1 is located higher than the upper surface of the cross rib 423.

As illustrated in FIGS. 3A and 4, the left wall 312 includes a flat plate portion 43 extending in a substantially vertical direction with a constant thickness, and a plurality of ribs 44 protruding rightward from a right surface 43a of the flat plate portion 43, and the inner wall surface 30a of the left wall 312 is entirely uneven. The ribs 44 include a longitudinal rib 441 extending in the front-rear direction and a plurality of transverse ribs 442 extending in the up-down direction. The longitudinal rib 441 is provided so as to coincide with the position of the screw hole 315. In FIG. 3A, the single longitudinal rib 441 is provided on the left wall 312, but the number of longitudinal ribs is not limited thereto, and a plurality of longitudinal ribs 441 may be provided at equal intervals in the up-down direction. Similarly to the lower wall 313, cross ribs may be provided on the inner wall surface 30a of the left wall 312 so as to cross the transverse ribs 442.

On the inner wall surface 30a of the left wall 312, an attachment region AR2 for the holding bar 20 is provided between the lower end of the left wall 312 and the longitudinal rib 441 on the upper side thereof. The plurality of transverse ribs 442 are present in the attachment region AR2. These transverse ribs 442 are provided at the same positions in the front-rear direction as the transverse ribs 422 on the lower wall 313. Therefore, the numbers of transverse ribs 442 and transverse ribs 422 are equal. The transverse ribs 442 may be provided at positions shifted in the front-rear direction with respect to the transverse ribs 422, and the number of transverse ribs 442 may be different from the number of transverse ribs 422.

In the attachment region AR2, an attachment surface SF2 for the holding bar 20 is formed as a machined surface (hatched). Specifically, as illustrated in FIG. 4, in the central portion or the lower portion in the up-down direction of the transverse rib 442 in the attachment region AR2, a high rib portion 445 higher than the other portion of the transverse rib 442 is formed in the casting step. Then, before the case 30 is assembled, that is, while the left wall 312 is in a separate state, the upper surface of the high rib portion 445 is machined to form an attachment surface SF2 on the same plane that extends in the front-rear direction.

As illustrated in FIGS. 3B and 4, the holding bar 20 is fixed to the lower wall 313 in a state where the outer end surface 21 of the holding bar 20 abuts against the attachment surface SF1 of the transverse rib 422. The holding bar 20 is fixed to the left wall 312 in a state where the outer end surface 21 of the holding bar 20 abuts against the attachment surface SF2 of the transverse rib 442. In the present embodiment, the plurality of holding bars 20 are used, but the plurality of holding bars 20 have the same configuration.

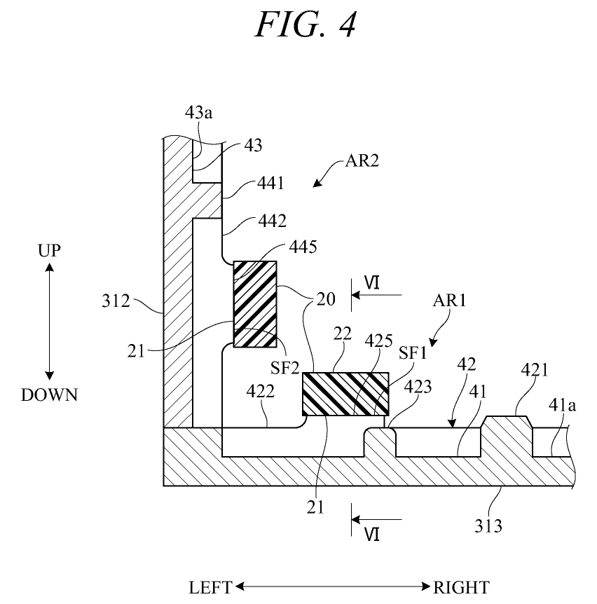

FIG. 5 is a plan view (a view indicated by an arrow V in FIG. 3B) illustrating a configuration of the holding bar 20 provided on the left side of the lower wall 313. As illustrated in FIG. 5, the holding bar 20 has a substantially rectangular parallelepiped shape as a whole, and has a front end surface 23, a rear end surface 24, and a pair of side surfaces 25 and 26 in addition to the outer end surface 21 on the lower side and the inner end surface 22 on the upper side. Of the pair of side surfaces 25 and 26, the side surface on which the lower wall 313 and the left wall 312 cross each other, that is, the left side surface 25 closer to a corner of the case 30 is referred to as corner side surface, and the opposite side surface 26 is referred to as central side surface.

Tabs 27 protrude forward and rearward from the front end surface 23 and the rear end surface 24, respectively, of the holding bar 20. A plurality of tabs 28 protrude leftward from the corner side surface 25 of the holding bar 20. The bottom surfaces of the tabs 27 and 28 extend, for example, on the same plane as the outer end surface 21. The bottom surfaces of the tabs 27 and 28 do not need to be located on the same plane as the outer end surface 21. Through holes 27a and 28a are open in central portions of the tabs 27 and 28, respectively.

As illustrated in FIG. 3A, a plurality of bosses 316 protrude from the inner wall surface 30a of the lower wall 313 to correspond to the positions of the tabs 27 and 28 when the holding bar 20 is attached. That is, as indicated by two-dot chain lines in FIG. 5, the bosses 316 are provided on the front side, the rear side, and the left side of the attachment region AR1. Substantially horizontal seating surfaces SF3 are formed as machined surfaces on end surfaces (upper surfaces) of the bosses 316. Also, bosses 316 protrude from the inner wall surface 30a of the left wall 312 to correspond to the positions of the tabs 27 and 28 when the holding bar 20 is attached. That is, the bosses 316 are provided on the front side, the rear side, and the lower side of the attachment region AR2, and substantially vertical seating surfaces SF4 are formed as machined surfaces on the end surfaces of the bosses 316. Screw holes are provided in the central portions of the seating surfaces SF3 and SF4.

As illustrated in FIG. 3B, on the upper side of the lower wall 313, bolts 29 passing through the tabs 27 and 28 are screwed into the screw holes of the seating surfaces SF3 on the lower wall 313, thereby fixing the holding bar 20 to the lower wall 313. Similarly, on the right side of the left wall 312, bolts 29 passing through the tabs 27 and 28 are screwed into the screw holes of the seating surfaces SF4 on the left wall 312, thereby fixing the holding bar 20 to the left wall 312. The holding bar 20 on the left wall 312 is attached so as to be reversed in the front-rear direction relative to the holding bar 20 (FIG. 5) on the lower wall 313. Thus, the tabs 28 of the holding bar 20 on the left wall 312 protrude downward.

As illustrated in FIG. 5, three tabs 28 protrude from the corner side surface 25 of the holding bar 20. A distance D1 from the rear end surface 24 to the left tab 28 of the holding bar 20 is longer (or shorter) than a distance D2 from the front end surface 23 to the right tab 28 of the holding bar 20. The center tab 28 is provided at a position shifted forward (or backward) from the center position of the holding bar 20 in the front-rear direction. As a result, as illustrated in FIG. 3B, the tabs 28 of the holding bar 20 on the lower wall 313 are disposed to be shifted in the front-rear direction relative to the tabs 28 of the holding bar 20 on the left wall 312. Therefore, the tabs 28 of the holding bar 20 on the lower wall 313 and the tabs 28 of the holding bar 20 on the left wall 312 do not interfere with each other, and these holding bars 20 can be disposed close to each other. Therefore, the pair of holding bars 20 can be easily disposed near the corner of the cell stacked body 10.

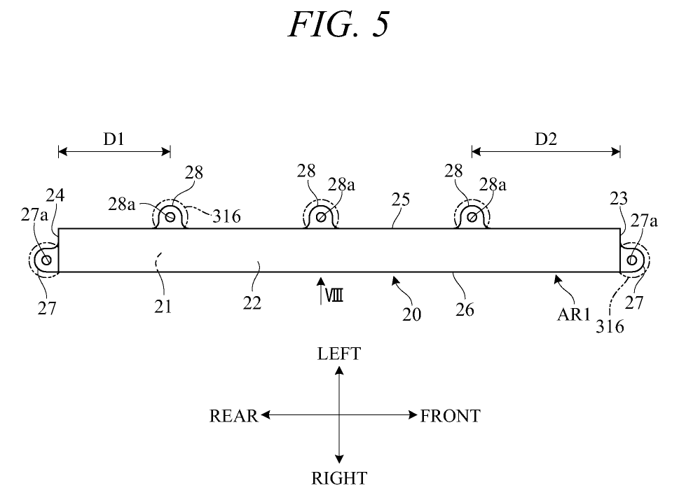

FIG. 6 is a cross-sectional view taken along line VI-VI of FIG. 4. FIG. 6 also illustrates a gap Δd between the outer surface 10a of the cell stacked body 10 and the inner end surface 22 of the holding bar 20. As illustrated in FIG. 6, the outer end surface 21 of the holding bar 20 abuts against the attachment surfaces SF1 at the upper ends of the plurality of transverse ribs 422 in the front-rear direction on the lower wall 313. At this time, there are gaps between the outer end surface 21 and the flat plate portion 41 and the cross ribs 423 on the lower wall 313 (see FIG. 4), and a plurality of communication flow paths PA0 partitioned in the front-rear direction by the transverse ribs 422 are formed between the outer end surface 21 and the flat plate portion 41. The height of the communication flow path PA0 (the height of the transverse rib 422) is sufficiently larger than the gap Δd between the cell stacked body 10 and the holding bar 20. The communication flow paths PA0 allow the right space (the lower space SP13 in FIG. 2) and the left space (the corner space SP15 in FIG. 2) of the holding bar 20 to communicate with each other. The plurality of communication flow paths PA0 are provided over substantially the entire length in the front-rear direction of the lower wall 313, so that the communication flow paths PA0 can have a sufficient flow path area.

Although not illustrated, a plurality of communication flow paths PA0 are also formed in the front-rear direction by the transverse ribs 442 between the outer end surface 21 of the holding bar 20 that abuts against the transverse ribs 442 on the left wall 312 and the flat plate portion 43 on the left wall 312. The communication flow paths PA0 allow the upper space (the left space SP12 in FIG. 2) and the lower space (the corner space SP15 in FIG. 2) of the holding bar 20 to communicate with each other. As a result, the lower space SP13 and the left space SP12 communicate with each other, that is, the closed space and the open space communicate with each other, via the communication flow paths PA0 provided between the transverse ribs 422 on the lower wall 313 and the communication flow paths PA0 provided between the transverse ribs 442 on the left wall 312.

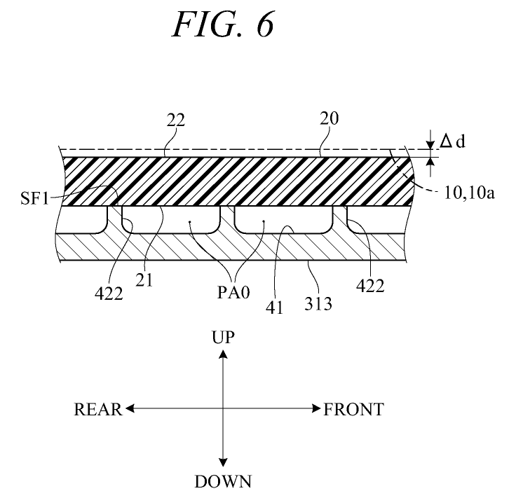

A main operation of the fuel cell stack 100 according to the present embodiment will be described. FIG. 7 is a cross-sectional view of a main portion of the fuel cell stack 100 schematically illustrating a flow of gas (air and fuel gas) in the spaces SP1 and SP2. As indicated by arrows A in FIG. 7, air flows into the surplus space SP1 between the case 30 (the lower case 30D) and the cell stacked body 10 through the ventilation ports 301 provided in the left wall 312 and the right wall 314. Air may not flow in from the ventilation ports 301, and the fuel gas accumulated in the surplus space SP1 may flow out of the ventilation ports 301.

In the surplus space SP1, as indicated by arrows B in FIG. 7, a flow of gas is generated through the communication flow paths PA0 between the holding bar 20 and the case inner wall surface 30a. That is, the gas flows between the left space SP12 and the lower space SP13, between the left space SP12 and the upper space SP11, between the right space SP14 and the lower space SP13, and between the right space SP14 and the upper space SP11. The plurality of communication flow paths PA0 are provided over substantially the entire length in the front-rear direction of the case 30, so that a gas flow can be generated in the entire area of the surplus space SP1.

The gas flowing through the communication flow paths PA0 contains fuel gas (hydrogen gas) having a lower specific gravity than air, and the gas rises in the surplus space SP1 and flows into the upper space SP2 via the communication port 35 in the upper wall 311. The gas in the space SP2 is discharged to the outside through the ventilation port 301 provided in the side wall (right wall) of the upper case 30U. A ventilation port for discharging gas may be provided in the upper wall of the upper case 30U. As a result, the entire area of the case can be ventilated, and the hydrogen concentration in the spaces SP1 and SP2 can be maintained at a predetermined value or less.

According to the present embodiment, the following functions and effects can be achieved.

A fuel cell stack 100 includes a cell stacked body 10 formed by stacking a plurality of power generation cells 1 in a front-rear direction, a case 30 and an end unit 40 surrounding the cell stacked body 10, and a plurality of holding bars 20 extending in the front-rear direction so as to divide a surplus space SP1 between a case inner wall surface 30a and an outer surface 10a of the cell stacked body 10 into a plurality of spaces SP11 to SP15 including a left space SP12 and a lower space SP13 (FIGS. 1, 2, and 3B). The case 30 has a case inner wall surface 30a facing the holding bars 20 (FIG. 2). The case inner wall surface 30a is formed in an uneven shape so as to form a communication flow path PA0 that allows the left space SP12 and the lower space SP13 to communicate with each other (FIGS. 3A and 6).

With this configuration, the open space facing the ventilation port 301 and the closed space not facing the ventilation port 301 can communicate with each other via the communication flow path PA0. Therefore, when the surplus space SP1 in the case 30 is divided into the plurality of spaces SP11 to SP15 by the holding bars 20, the gas can flow into the spaces through the communication flow paths PA0 facing the holding bars 20. As a result, the entire surplus space SP1 in the case can be efficiently ventilated, and the hydrogen gas accumulated in the surplus space SP1 can be favorably discharged to the outside.

The holding bar 20 has an outer end surface 21 facing the case inner wall surface 30a and an inner end surface 22 facing the outer surface 10a of the cell stacked body 10 (FIG. 2). The case inner wall surface 30a includes substantially plate-shaped flat plate portions 41 and 43, and a plurality of ribs 42 and 44, particularly transverse ribs 422 and 442, protruding from the flat plate portions 41 and 43 so as to cross the outer end surfaces 21 of the holding bars 20 (FIG. 3A). The communication flow paths PA0 are provided between the plurality of transverse ribs 422 and between the transverse ribs 442 (FIG. 4). As a result, the rib structure makes it possible to ensure the strength of the case 30 and favorably form the communication flow paths PA0 on the case inner wall surface 30a without increasing the size of the case 30.

The holding bar 20 is an impact receiving member (restraining member) that receives an impact acting on the fuel cell stack 100 (the cell stacked body 10) and restrains a position of the cell stacked body 10. The fuel cell stack 100 further includes bolts 29 that fix the holding bar 20 to the inner wall surface 30a of the case 30 in a state where the outer end surface 21 of the holding bar 20 abuts against end surfaces (attachment surfaces SF1 and SF2) of the transverse ribs 422 and 442 (FIG. 3B). By forming the case inner wall surface 30a in an uneven shape, it is not necessary to machine the holding bar 20 as an impact receiving member to provide flow paths, so that the holding bar 20 can be easily formed. In addition, the strength of the holding bar 20 can be ensured, and a sufficient function as an impact receiving member can be exhibited.

The case 30 substantially has a box shape (FIG. 1). The holding bars 20 are disposed near a corner of the cell stacked body 10 (FIG. 2). By disposing the holding bars 20 near the corner having high rigidity as described above, the cell stacked body 10 can be firmly held, and the positional shift of the power generation cell 1 can be effectively suppressed.

The holding bars 20 are disposed on both sides of the corner of the cell stacked body 10 so as to sandwich the corner of the cell stacked body 10 (FIG. 2). Thus, the cell stacked body 10 can be more firmly held by the holding bars 20.

The holding bar 20 is provided such that a gap Δd of a predetermined distance exists between the outer surface 10a of the cell stacked body 10 and the inner end surface 22 of the holding bar 20, and the height of the transverse ribs 442 is higher than the predetermined distance (FIG. 6). As a result, the areas of the communication flow paths PA0 can be made sufficiently larger than the area of the gap Δd, and the gas can be easily ventilated via the communication flow paths PA0.

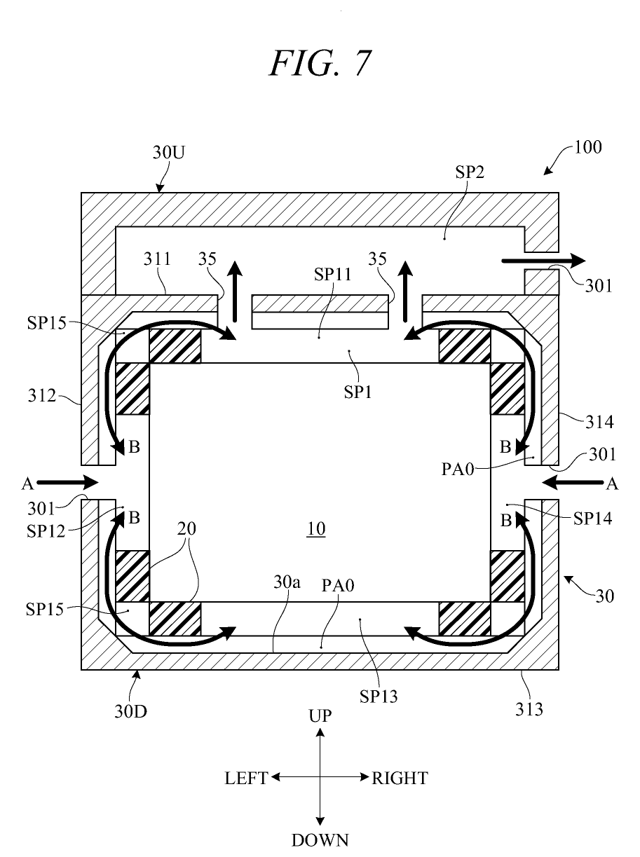

FIG. 8 is a view indicated by an arrow VIII in FIG. 5. As illustrated in FIG. 8, in the present embodiment, a holding bar 20 long in the front-rear direction and made of resin is used for the fuel cell stack 100. The holding bar 20 functions as an impact receiving member (restraining member). Therefore, in order to ensure the strength of the holding bar 20, the holding bar 20 needs to have a predetermined thickness or more (a length in the up-down direction in FIG. 8). When the long and thick holding bar 20 is molded as described above, deformation may occur due to shrinkage of the resin, and the holding bar 20 may warp into a mountain shape as indicated by a two-dot chain line L1 in FIG. 8. As a result, it is difficult to provide a predetermined gap Δd (FIG. 6) between the holding bar 20 and the outer surface 10a of the cell stacked body 10 over the entire length of the holding bar 20, and a part of the holding bar 20 may come into contact with the cell stacked body 10 at the time of assembling the fuel cell stack 100. A configuration of the holding bar 20 for preventing such contact will be described below.

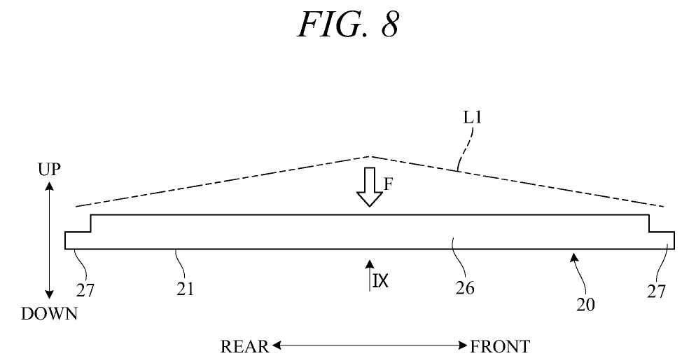

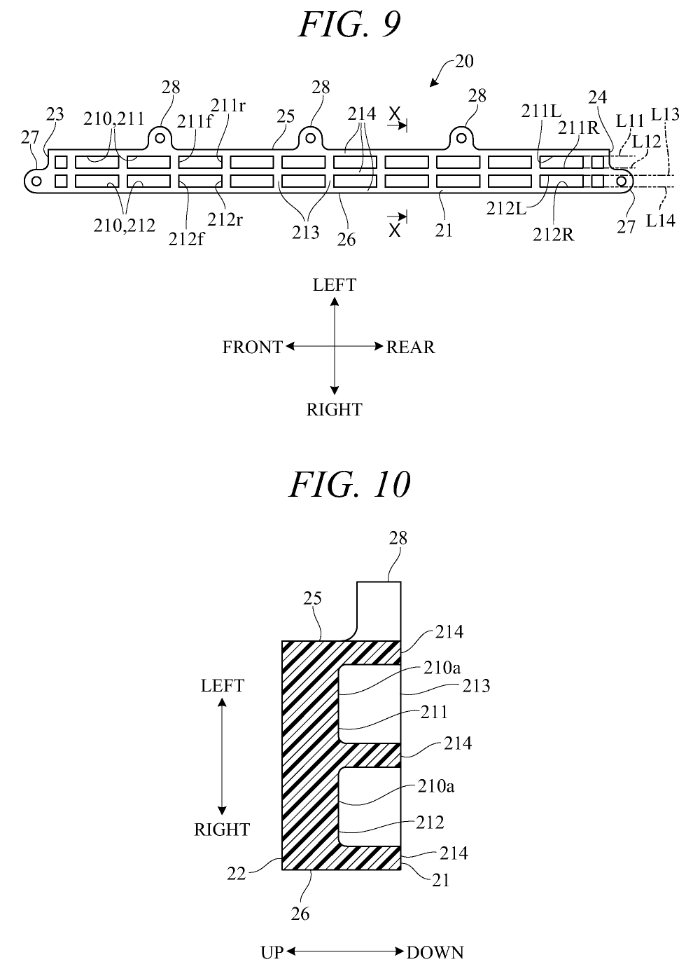

FIG. 9 is a bottom view (a view indicated by an arrow IX in FIG. 8) of the holding bar 20 attached to the left side of the lower wall 313 in a separate state, and FIG. 10 is a cross-sectional view taken along line X-X of FIG. 9. In FIG. 9, the front-rear direction is illustrated as being reversed from that illustrated in FIG. 5.

As illustrated in FIGS. 9 and 10, a plurality of recesses 210 are provided in the outer end surface 21 of the holding bar 20. More specifically, the recesses 210 include a plurality of corner recesses 211 provided on the corner side surface 25 side and a plurality of central recesses 212 provided on the central side surface 26 side. The recesses 211 and 212 have the same shape (width and depth), and are substantially rectangular and elongated along the longitudinal direction. However, the recesses 211 and 212 have a substantially square shape at the ends in the front-rear direction.

A front edge 211f and a rear edge 211r of each of the corner recesses 211 and a front edge 212f and a rear edge 212r of each of the central recesses 212 are located at the same positions in the front-rear direction. Therefore, with respect to bottom surfaces 210a of the recesses 210 (211 and 212), a plurality of ribs 213 (referred to as short ribs) protruding downward from the corner side surface 25 to the central side surface 26 between the front edges 211f and 212f and the rear edges 211r and 212r of the recesses 211 and 212 are provided on the outer end surface 21 of the holding bar 20. The plurality of short ribs 213 are provided at equal intervals in the front-rear direction over the entire length of the holding bar 20. The plurality of short ribs 213 are provided so as to be shifted in position in the front-rear direction with respect to the plurality of tabs (protruding portions) 28. The plurality of short ribs 213 have the same width (length in the front-rear direction)

A left edge 211L and a right edge 211R of each of the plurality of corner recesses 211 are positioned on virtual straight lines (only partially illustrated) L11 and L12 extending in the front-rear direction, respectively. A left edge 212L and a right edge 212R of each of the plurality of central recesses 212 are positioned on virtual straight lines (only partially illustrated) L13 and L14 extending in the front-rear direction, respectively. Therefore, with respect to the bottom surfaces 210a of the recesses 210 (211 and 212), a plurality of (three) ribs (referred to as long ribs) 214 protruding downward from the front end surface 23 to the rear end surface 24 between the corner side surface 25 and the left edges 211L of the corner recesses 211, between the right edges 211R of the corner recesses 211 and the left edges 212L of the central recesses 212, and between the right edge 212R of the central recesses 212 and the central side surface 26 are provided on the outer end surface 21 of the holding bar 20. The plurality of long ribs 214 have the same width (length in the left-right direction)

By providing the plurality of recesses 210 on the bottom surface (the outer end surface 21) of the holding bar 20 in this manner, the moldability of the holding bar 20 is improved, making it possible to prevent warpage. In addition, the weight of the holding bar 20 can be reduced, and the material cost can be reduced. Furthermore, since the holding bar 20 has a rib structure in which the plurality of ribs 213 and 214 protrude with respect to the bottom surfaces 210a, sufficient strength can be ensured. In consideration of the moldability of the holding bar 20, some of the recesses 210 may be omitted, or the shape of some of the recesses 210 may be changed.

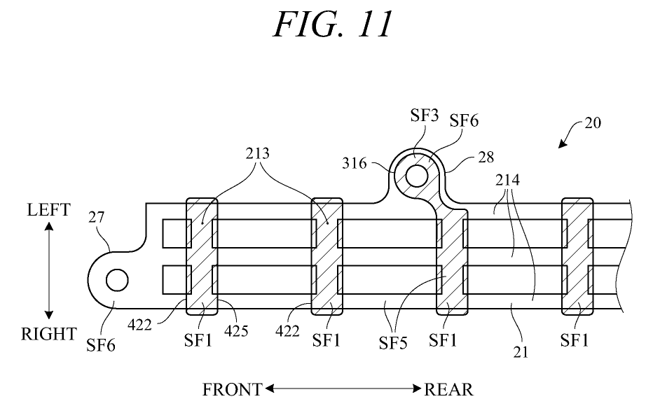

FIG. 11 is an enlarged view of a main portion of FIG. 9, specifically, an enlarged view of a front portion of the outer end surface 21 of the holding bar 20. In FIG. 11, the positions of the attachment surfaces SF1 and the seating surface SF3 on the lower wall 313 to which the holding bar 20 is attached (see FIG. 3A) are indicated by hatching for convenience. As illustrated in FIG. 11, the outer end surface 21 of the holding bar 20 includes end surfaces (rib surfaces SF5) of the ribs 213 and 214 and bottom surfaces SF6 of the tabs 27 and 28.

The plurality of short ribs 213 are provided so as to coincide with the attachment surfaces SF1 of the plurality of transverse ribs 422 arranged in the front-rear direction. Accordingly, when the holding bar 20 is attached, the attachment surfaces SF1 of the transverse ribs 422 of the case 30 and the rib surfaces SF5 of the short ribs 213 of the holding bar 20 abut against each other. As a result, when an impact load acts on the fuel cell stack 100 in the up-down and left-right directions, the deformation of the holding bar 20 can be favorably suppressed.

The long ribs 214 extend over the entire length of the holding bar 20 in the front-rear direction without interruption. As a result, if a bending load F (FIG. 8) acts on holding bar 20 due to the impact load, the deformation of the holding bar 20 can be favorably suppressed, and the positional shift of the power generation cell 1 can be suppressed.

Although different from FIG. 3A, in FIG. 11, the transverse rib 422 and the boss 316 of the case 30 are provided continuously, whereby the attachment surface SF1 and the seating surface SF3 are provided continuously without being separated. Therefore, the entire bottom surface area from the short rib 213 to the tab 28 of the holding bar 20 abuts against the entire area from the attachment surface SF1 to the seating surface SF3 of the case 30. As a result, stress generated in the case 30 and the holding bar 20 when an impact load acts (such as stress generated at the base of the thin tab 28) can be reduced. Not only the front boss 316 but also the rear and central bosses 316 may be formed to be continuous with the transverse ribs 422 similarly to the front boss 316, and the short ribs 213 and the tabs 28 may be provided on the holding bar 20 to correspond thereto.

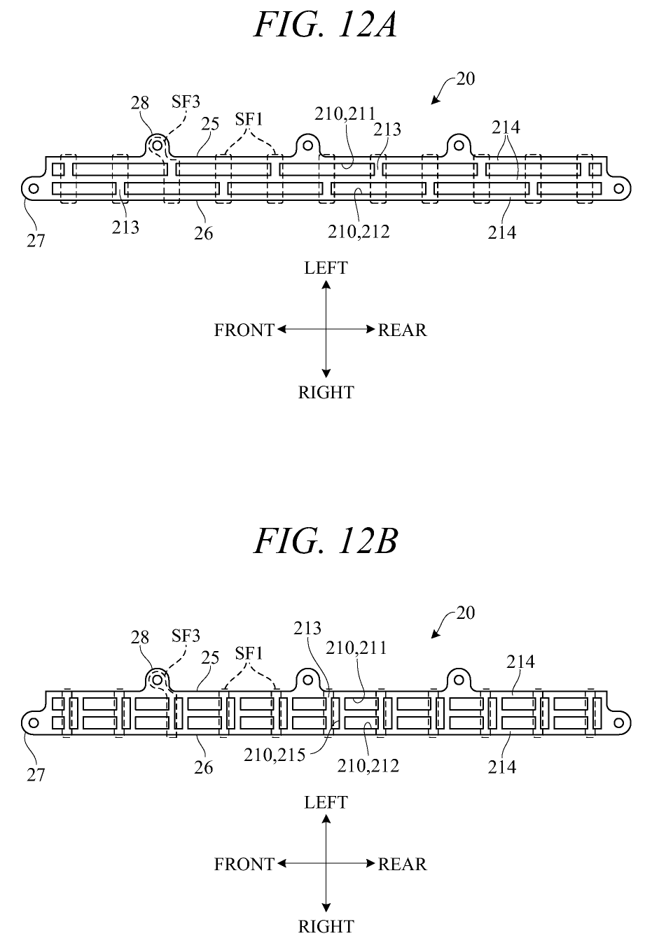

The form of the recesses 210 of the holding bar 20 is not limited to that illustrated in FIG. 9. FIGS. 12A and 12B are diagrams illustrating modifications of FIG. 9, respectively. In the drawings, the positions of the attachment surfaces SF1 and the positions of some of the seating surfaces SF3 of the case 30 (the lower wall 313) to which the holding bar 20 is attached are indicated by dotted lines for convenience.

In the example of FIG. 12A, the corner recesses 211 and the central recesses 212 extend further in the front-rear direction than those in FIG. 9, and the corner recesses 211 and the central recesses 212 are provided to be shifted in position in the front-rear direction. That is, the corner recesses 211 and the central recesses 212 are alternately arranged in the front-rear direction, that is, arranged in a staggered manner. As a result, the sizes of the recesses 210 increase, making it possible to further reduce the weight of the holding bar 20. In this case, although the length (length in the left-right direction) of the short rib 213 abutting against the case 30 is shorter than that in FIG. 9, it is sufficient to ensure the strength of the holding bar 20.

In the example of FIG. 12B, the corner recesses 211 and the central recesses 212 are formed to have a shorter length (particularly, length on the front side) in the front-rear direction than those in FIG. 9. Further, recesses 215 are additionally provided adjacent to the short ribs 213 at portions where the recesses 211 and 212 are shortened. Therefore, in the example of FIG. 12B, the number of recesses 210 (211, 212, and 215) increases. The recesses 215 extend to be elongated in the left-right direction. In other words, in the example of FIG. 12B, the horizontally long recesses 211 and 212 and the vertically long recesses 215 are alternately provided in the longitudinal direction of the holding bar 20. In both the examples of FIGS. 12A and 12B, the long ribs 214 are provided over the entire length of the holding bar 20. Therefore, the sufficient strength of the holding bar 20 against the bending load F (FIG. 8) can be ensured.

According to the present embodiment, the following functions and effects can be further achieved.

(1) A fuel cell stack 100 includes a cell stacked body 10 formed by stacking a plurality of power generation cells 1 in a front-rear direction, a case 30 and an end unit 40 surrounding the cell stacked body 10, and a holding bar 20 made of resin, the holding bar 20 being disposed in a surplus space SP1 between a case inner wall surface 30a and an outer surface 10a of the cell stacked body 10, having an outer end surface 21 facing the case inner wall surface 30a, and extending in the front-rear direction (FIGS. 1 and 2). The case inner wall surface 30a has transverse ribs 422 protruding toward the outer end surface 21 (FIG. 3A). The outer end surface 21 has ribs 213 and 214 protruding toward the case inner wall surface 30a (FIGS. 9, 12A, and 12B). The ribs of the outer end surface 21 include short ribs 213 provided so as to abut against end surfaces (attachment surfaces SF1) of the transverse ribs 422 of the case 30 (FIG. 11).

Since the holding bar 20 is configured to be long and thick, it is likely to occur due to shrinkage at the time of resin molding. However, the above configuration improves the moldability of the holding bar 20, thereby suppressing deformation such as warpage. Further, since the short ribs 213 abut against the transverse ribs 422 of the case 30, the holding bar 20 having a rib structure can be firmly supported without impeding the flow of gas through the communication flow paths PA0 between the transverse ribs 422.

(2) On the case inner wall surface 30a, a plurality of transverse ribs 422 are formed (FIG. 3A). On the outer end surface 21 of the holding bar 20, a plurality of short ribs 213 provided to correspond to the plurality of transverse ribs 422, and recesses 210 provided between the plurality of short ribs 213, are provided (FIGS. 9, 12A, and 12B). As a result, the holding bar 20 has a lightening structure, making it possible to reduce the weight of the holding bar 20, and reduce the material cost.

(3) The ribs of the holding bar 20 include long ribs 214 extending in the front-rear direction and a plurality of short ribs 213 extending in a direction (left-right direction) crossing the long ribs 214 (FIGS. 9, 12A, and 12B). With such a rib structure, the holding bar 20 can be firmly configured while reducing its weight.

(4) The long ribs 214 extend over the entire length in the front-rear direction of the holding bar 20 (FIGS. 9, 12A, and 12B). As a result, if a bending load F acts on the holding bar 20 due to an impact load, the deformation of the holding bar 20 can be favorably suppressed, and the positional shift of the power generation cell 1 can be suppressed.

(5) The plurality of short ribs 213 are provided at equal intervals in the front-rear direction (FIGS. 9, 12A, and 12B). As a result, the holding bar 20 is uniformly supported by the case 30 over its entire area, making it possible to prevent a large load from locally acting on the holding bar 20.

(6) The case inner wall surface 30a has seating surfaces SF3 for fixing the holding bar 20, the seating surfaces SF3 being continuous with attachment surfaces SF1 of the transverse ribs 422 of the case 30 (FIG. 11). The outer end surface 21 of the holding bar 20 further has bottom surfaces SF6 of tabs 28 that abut against the seating surfaces SF3 of the transverse ribs 422 (FIG. 11). The bottom surfaces SF6 of the tabs 28 are continuous with end surfaces (rib surfaces SF5) of the short ribs 213 (FIG. 11). As a result, it is possible to reduce stress generated in the case 30 and the holding bar 20 when an impact load acts.

The above embodiment can be modified in various forms. Below, some modified examples are described. In the above embodiment, the case 30 as a housing is configured by the lower case 30D and the upper case 30U, but the case 30 may be configured by only the lower case 30D. In the above embodiment, the case 30 is formed in a substantially box shape, but the shape of the housing is not limited to the one described above. In the above embodiment, a communication flow path PA0 is formed in the case inner wall surface 30a with the transverse ribs 422 and 442. However, as long as an inner surface of the housing has a rib (rib on a housing side) protruding towards the outer end surface 21 of the holding bar 20, the configuration of the inner surface of the housing is not limited to the one described above.

In the above embodiment, the ribs 213 and 214 (a rib on a restraining member side) are protruded toward the case inner wall surface 30a on the outer end surface 21 (a facing surface) of the holding bar 20 as a restraining member made of resin. However, as long as including ribs provided to abut the end surface (attachment surface SF1 of the holding bar 20) of the ribs on the case inner wall surface 30a, that is, an abutment rib, the configuration of the rib on restraining member side may be any configuration. In the above embodiment, multiple short ribs 213 (second ribs) are included in the abutment rib, but the configuration of the second rib is not limited to those described above. In the above embodiment, ribs are formed on the holding bar 20 by providing recesses 210 on the outer end surface 21 of the holding bar 20. However, instead of providing recesses, ribs may be protruded from a plate-shaped member.

In the above embodiment, multiple long ribs 214 (first ribs) are provided over the entire length of the holding bar 20, but the configuration of the first rib is not limited to those described above. In the above embodiment, the holding bar 20 is formed to have a substantially rectangular cross-section, and a pair of holding bars 20 are arranged to sandwich the corner portion of the cell stacked body, but the configuration of a constraining member is not limited to those described above. For example, the constraining member may be configured in a substantially L-shape to cover the corner portion of the cell stacked body 10. In the above embodiment, the case inner wall surface 30a is provided with a seating surface SF3 (a flange surface on the housing side) for fixing the holding bar 20, which is continuously formed with the end surface of the transverse rib 422 (attachment surface SF1), but the configuration of the flange surface on the housing side is not limited to those described above. In the above embodiment, the outer end surface 21 of the holding bar 20 is provided with a bottom surface SF6 (a flange surface on the constraining member side) that abuts against the seating surface SF3, but the configuration of the flange surface on the constraining member side is not limited to those described above.

The above embodiment can be combined as desired with one or more of the above modifications. The modifications can also be combined with one another.

According to the present invention, a constraining member made of resin can be accurately configured.

Above, while the present invention has been described with reference to the preferred embodiments thereof, it will be understood, by those skilled in the art, that various changes and modifications may be made thereto without departing from the scope of the appended claims.

What is claimed is:

1. A fuel cell stack comprising:
a cell stacked body including a plurality of power generation cells stacked in a predetermined direction;
a housing surrounding the cell stacked body; and
a restraining member made of a resin and disposed in a space between an inner surface of the housing and an outer surface of the cell stacked body, the restraining member having a facing surface opposed to the inner surface and extending in the predetermined direction, wherein
the inner surface includes a rib on a housing side protruding toward the facing surface,
the facing surface includes a rib on a restraining member side protruding toward the inner surface, and
the rib on the restraining member side includes an abutment rib provided so as to abut against an end surface of the rib on the housing side.

2. The fuel cell stack according to claim 1, wherein
the rib on the housing side is one of a plurality of ribs on the housing side provided on the inner surface,
the abutment rib is one of a plurality of abutment ribs provided on the facing surface and corresponding to the plurality of ribs on the housing side, and
recesses are provided between the plurality of abutment ribs on the facing surface.

3. The fuel cell stack according to claim 2, wherein
the rib on the restraining member side includes a first rib extending in the predetermined direction, and a plurality of second ribs extending in a direction intersecting the first rib and including the plurality of abutment ribs.

4. The fuel cell stack according to claim 3, wherein
the first rib extends over an entire length in the predetermined direction of the restraining member.

5. The fuel cell stack according to claim 3, wherein
the plurality of second ribs are provided at equal intervals in the predetermined direction.

6. The fuel cell stack according to claim 1, wherein
the inner surface includes a flange surface on the housing side at which the restraining member is fixed, the flange surface on the housing side being formed continuously with the end surface of the rib on the housing side,
a flange surface on the restraining member side is further formed on the facing surface so as to abut against the flange surface on the housing side, and
the flange surface on the restraining member side is continuous with an end surface of the abutment rib.

7. The fuel cell stack according to claim 1, wherein
the cell stacked body has a substantially rectangular parallelepiped shape, and
the restraining member is one of a pair of restraining members arranged on both sides of a corner portion of the cell stacked body so as to sandwich the corner portion therebetween.

8. The fuel cell stack according to claim 2, wherein
the restraining member includes a plurality of protruding portions at which the restraining member is fixed, the plurality of protruding portions protruding from a side surface extending in the predetermined direction of the restraining member, and
the plurality of abutment ribs are shifted in the predetermined direction relative to the plurality of protruding portions.
